(19) United States
(12) Patent Application Publication
(10) Pub. No.: US 2024/0223251 A1
(43) Pub. Date: Jul. 4, 2024

(54) MACHINE LEARNING FOR WIRELESS COMMUNICATION

(71) Applicant: Telefonaktiebolaget LM Ericsson (publ), Stockholm (SE)

(72) Inventors: Heunchul LEE, Täby (SE); Jaeseong JEONG, Solna (SE)

(21) Appl. No.: 18/557,374

(22) PCT Filed: Apr. 29, 2021
(86) PCT No.: PCT/SE2021/050397

§ 371 Date: Oct. 26, 2023

(51) Int. Cl. H04B 7/06

(52) U.S. Cl. CPC H04B 7/0617

(57) ABSTRACT

There is disclosed a machine learning system. The machine learning system is configured to provide an output based on an input, the input representing a status of a wireless communication system comprising a plurality of radio nodes, the output representing an action for the wireless communication system, the machine learning system is configured for a phase ambiguity limitation regarding the output. The disclosure also pertains to related devices and methods, for example radio nodes and a wireless communication system.

### TECHNICAL FIELD

This disclosure pertains to machine learning, in particular to machine learning in the context of wireless communication.

### BACKGROUND

The area of wireless communications is undergoing an explosive development, penetrating ever wider segments of society and industry. Next-generation wireless communication networks will be addressing a number of new use cases. Apart from expected enhancements in mobile broadband—for example, driven by emerging extended reality (XR) applications new services, such as, e.g., ultra-reliable low-latency and massive machine-type communications pose a number of rather challenging requirements on future communication networks, starting from higher data rates, lower latency to higher energy efficiency and lower operational and capital expenditures. Consequently, such networks are expected to be rather complex and difficult to model, analyze and manage in traditional ways.

Moreover, as an explicit trend of densification is observed, more complex operation regimes and environments are anticipated. Artificial intelligence, in particular machine learning systems, seems a promising tool for handling such complex networks.

### SUMMARY

It is an object of this disclosure to provide improved machine learning for wireless communication. The object is achieved based on the realisation that for many parametrisations of wireless systems, there exists a phase ambiguity. It is generally proposed to limit the phase ambiguity, allowing more efficient and better processing in the context of machine learning. In particular, fewer teaching steps might be necessary to achieve a desired result, and/or improved results of machine learning (ML) may be achieved.

There is disclosed a (e.g., first) machine learning system (MLS). The (first) machine learning system is adapted to provide an output based on an input. The input represents a status of a wireless communication system comprising a plurality of radio nodes. The output represents an action for the wireless communication system. The machine learning system is adapted for a phase ambiguity limitation regarding the output. This may be part of training the machine learning system. Alternatively, or additionally, the machine learning system may be trained, and/or adapted to be trained, based on a phase ambiguity limitation regarding the input.

A (e.g., second) machine learning system may be considered (e.g., alternatively, or additionally). The machine learning system (MLS) may be adapted to provide an output based on an input, the input representing a status of a wireless communication system comprising a plurality of radio nodes. The output represents an action for the wireless communication system. The machine learning system is and/or has been trained, and/or operates, based on a phase ambiguity limitation regarding the output and/or the regarding the input. Alternatively, or additionally, it may be considered that the (second) MLS is trained based on a phase ambiguity limitation regarding the input. It may be considered that the MLS is and/or has been trained such that the MLS is set up to provide output based on training that has been finished (e.g., an initial training), and/or that the MLS is intended for operation after training, e.g. a machine learning based training. The (second) MLS may in particular be adapted to operate and/or control the wireless communication system during operation (normal operation); training updates may be considered, and/or phase ambiguity limitation (e.g. regarding the input and/or the output (e.g. regarding the input and/or the output, e.g. for limiting input and/or output spaces even during operation and/or for consistency with the training) may be used during non-training operation and/or during operation for controlling the wireless communication system. In general, the (second) MLS may be considered a trained system, the (first) MLS may be a system to be trained. Features in the following disclosure may pertain to either or both first and second MLS, and/or to training and/or non-training operation. A second machine learning system may be adapted with one or more features of a first machine learning system and vice versa.

Approaches described herein allow limiting ambiguity in solutions for controlling wireless communication. This can lead to improved processing, with fewer steps of learning to achieve a desired output quality, and/or providing higher quality solutions.

In general, the action may correspond to control information and/or control parameters for the wireless communication system, e.g. enabling and/or causing and/or being suitable to enable or cause nodes or devices of the wireless communication system to perform MIMO operation and/or beamforming. The plurality of radio nodes may in particular comprise 4 or more, or 8 or more, or 16 or more, or 64 or more radio nodes; the radio nodes may comprise and/or be connected to and/or control one or more transmission points (TRP) each.

In general, a machine learning system may be a system adapted for performing machine learning, in particular deep learning, and/or implemented as, and/or comprising one or more neural networks which may be interconnected or interconnectable. The neural network may comprise e.g. one or more ANNs and/or CNNs. An ANN may be associated and/or adapted for controlling a radio node of the wireless communication system, and/or may be adapted to provide operation information to another neural network, e.g. a centralised network and/or CNN. Based on the output of the MLS, learning feedback may be provided to an ANN and/or a radio node (or a plurality thereof); the learning feedback may represent an action or actions or parameters for action for the radio node, e.g. as representing a part of the output or solution for the system. It may be considered that a MLS is adapted to control, and/or provide control information for, the wireless communication system, in particular one or more of the radio nodes. The output may represent and/or correspond to control information for the radio nodes, e.g. to control one or more actions to be performed by the system and/or one or more radio nodes. A method of operating a MLS may comprise controlling the wireless communication system based on the output. Different nodes may be controlled based on, and/or provided with, different parts of the output, e.g. concerning parameters pertaining to the individual nodes. A phase ambiguity limitation in general may limit the available phase formats and/or available action space, thus the space of available solutions. For example, solutions with different phases, but equivalent optimisation parametrisation (e.g., capability) may be mapped to one phase representation, and/or only one phase representation may be available for the solution. ML may in general comprise providing multiple cycles of input and output, for optimisation; a trained system may be able to find good/optimised solutions for different system statuses. ML may utilise one or more CNNs, in particular a centralised CNN, which may provide learning for a plurality of ANN associated to different components (e.g., radio nodes) of the wireless communication system.

A machine learning system may in general be considered adapted for a phase ambiguity limitation regarding the output if it is set up to limit solutions or output regarding phase ambiguity, e.g. according to a configuration or setup or programming or circuit arrangements. The machine learning system may be adapted for performing one or more processing actions for such limitation, and/or only allow limited solutions, e.g. mapped to a part of an allowed phase space or solution space or action space or phase format. An output may generally represent a solution and/or an action, which may be obtained and/or computed and/or determined by the machine learning system. A wireless communication system may be considered and/or implemented as beamforming system, e.g. using antenna arrays or antenna arrangements for beamforming. A machine learning system may be connected or connectable to a wireless communication system, e.g. to one or more nodes thereof, e.g. a radio nodes or network nodes, and/or one or more control nodes, e.g. higher layer node of the wireless communication system. In general, a MLS may be implemented as, and/or comprise, one or more integrated circuitries and/or processing circuitry, and/or one or more interfaces to the wireless communication system, and/or may be implemented as hardware and/or firmware and/or software, e.g. as a neural network and/or associated data and/or interconnections and/or representations.

In general, a MLS may be trained to find an optimised solution (action/output) based on one or more optimisation parameters, or an optimisation parametrisation, which may be considered an optimisation condition or target. In some cases, the optimisation condition may be represented by, and/or pertain to a capacity of the wireless communication system, and/or a throughput and/or latency. At least one optimisation parameter, and/or the optimisation parametrisation, may be invariant to phase shifts of an action or output, and/or invariant to phase shifts of an input or status. A phase format may pertain to a solution in phase space, in particular such that one, or at least one, or more than one, phase parameter is fixed or prescribed. A phase ambiguity limitation may define an integer number of allowable phase formats, e.g. 4 or less, or 2 or less, or one. For each phase format, each solution may share the fixed phase parameter/s according to the phase format.

A machine learning system may in general be considered adapted for a phase ambiguity limitation regarding the input if it is set up to limit input regarding phase ambiguity, e.g. according to a configuration or setup or programming or circuit arrangements. The machine learning system may be adapted for performing one or more processing actions for such limitation, and/or only limited input, e.g. mapped to a part of an allowed phase space or solution space or action space or phase format. In particular, the machine learning system may be adapted to map operation information or other information provided for input to an allowable input, e.g. transform to a fixed phase format, or reject information not in the format. An input may generally represent a status of the wireless communication system, e.g. representing operation information and/or radio environment and/or channel estimate and/or status of one or more ANNs.

A wireless communication system may be considered and/or implemented as beamforming system, e.g. using antenna arrays for beamforming. A machine learning system may be connected or connectable to a wireless communication system, e.g. to one or more nodes thereof, e.g. a radio nodes or network nodes, and/or one or more control nodes, e.g. higher layer node of the wireless communication system. In general, a MLS may be implemented as, and/or comprise, one or more integrated circuitries and/or processing circuitry, and/or one or more interfaces to the wireless communication system, and/or may be implemented as hardware and/or firmware and/or software. In general, a MLS may be trained to find an optimised solution (action/output) based on one or more optimisation parameters, or an optimisation parametrisation, which may be considered an optimisation condition or target. In some cases, the optimisation condition may be represented by, and/or pertain to a capacity of the wireless communication system, and/or a throughput and/or latency. At least one optimisation parameter, and/or the optimisation parametrisation, may be invariant to phase shifts of an action or output, and/or invariant to phase shifts of an input or status. A phase format may pertain to a solution in phase space, in particular such that one, or at least one, or more than one, phase parameter is fixed or prescribed. A phase ambiguity limitation may define an integer number of allowable phase formats, e.g. 4 or less, or 2 or less, or one. For each phase format, each solution may share the fixed phase parameter/s according to the phase format.

A phase ambiguity limitation or elimination may generally be based on a function, e.g. a phase ambiguity elimination (PAE) function. ƒ_{PAE} or a limitation function ƒ_{PAL}. The function may correspond to, and/or be represented or representable by, a phase rotation or multiplication or phase shift of a matrix representing a potential input (before application of the function), e.g. corresponding to a negative phase component of one matrix element (e.g., the same element for all possible inputs); such transformation may result in the specific matrix element having always a predetermined value for a phase term or factor (or mathmatical equivalent), the other elements may be rotated (multiplied). Co-phasing of an element may be considered, e.g. for an output.

The radio nodes of the wireless communication system may be adapted for, and/or controlled or controllable, for beamforming, e.g. based on the action. In general, the wireless communication system may be operable or operated in a non-codebook based mode or operation. Accordingly, the action space available may be essentially continuous. Approaches described herein are particularly suitable for such systems, which provide great flexibility, at the cost of high processing and/or optimisation effort. Phase ambiguity limitation may significantly lower such efforts. The action and/or output may in particular represent a precoder, e.g. one not included in a codebook (for non-codebook based operation). The radio nodes may in particular be network nodes and/or base stations or TRPs; wireless devices or UEs may be in communication with them utilising radio links and/or radio channels. In general, the output and/or action may pertain to transmission and/or reception by a radio node of the wireless communication system, e.g. using beams. Precoding may be for transmission beamforming and/or reception beamforming for a network node.

Input for the MLS may comprise and/or represent operation information, e.g. based on measurements performed on radio channels by radio nodes, and/or operation conditions or performance, and/or representing parameters, e.g. beamforming parameters, used for controlling the radio node/s, in particular for MIMO and/or beamforming operation, and/or a status of a ANN controlling the radio node/s. Measurements may be represented by measurement information and/or channel estimation may be based on measurements. The input may comprise operation information from, and/or pertaining to, a plurality of nodes and/or ANNs.

It may be considered that the output and/or action may correspond to, and/or represent, and/or comprise, a set of beamforming parameters (e.g., precoder or precoding matrix) and/or a representation thereof. The beamforming parameters may be beamforming weights, e.g. for phase and/or amplitude, and/or may pertain to one or more of the radio nodes and/or antenna arrays thereof. Thus, beamforming control is facilitated.

In some variants, the status may represent a channel estimate of the wireless communication system. The channel estimate may cover a plurality of radio channels pertaining to, and/or associated, to the wireless communication system and/or the radio nodes; the channels may be estimated based on an action and/or output of the MLS, e.g. based on measurements and/or system performance. Performance may be represented by and/or pertain to error rate and/or throughput and/or wireless device served and/or Quality of Service parameters and/or latency requirements. Accordingly, the relation between channel estimate and action may be optimised. A channel estimate may be based on, and/or be representative of, channel state information, e.g. corresponding measurement reports (e.g., provided by wireless devices or user equipments, based on control signaling from network nodes).

It may be considered that the (output) phase ambiguity limitation may be a phase ambiguity elimination. An elimination may lead to no phase ambiguity being left for determining the output, e.g. such that all outputs are mapped to a prescribed phase format, or only certain formats may be considered a solution for the MLS.

It may be considered that the output corresponds to, and/or comprises, a set of beamforming weights. Beamforming weights may be a suitable parametrisation for beamforming, and may be provided in a normalised form and/or as a precoder or precoding matrix.

The output may represent one action from an action space of available actions. The action space may be limited to certain phase formats, e.g. one phase format, or a small number of such (e.g., 8 or fewer, or 4 or fewer).

In general, the (output) phase ambiguity limitation may limit an action space of available actions. The (output) phase ambiguity limitation may in particular limit an action space of available action by fixing at least one element or parameter of a beamforming weight representation. For example, a phase component of a parameter or value or matrix element may be fixed; this may be considered corresponding to fixing a phase format. Thus, a suitable and manageable representation of actions/output may be provided.

It may be considered that the action may be determined based on a capacity of the beamforming system. The capacity may be considered an optimisation parameter or parametrisation; it may provide a sufficiently high level representation of the system performance.

In general, the action may be determined based on an optimisation of the beamforming system, e.g. based on an optimisation parametrisation or parameter. An ML approach as described herein may provide good results for such optimisation, in particular in terms of processing speed (finding an optimised solution) and quality (e.g., regarding a desired optimisation parametrisation).

The machine learning system may comprise on or more critic neural networks and/or one or more agent (also referred to as actor) neural networks. The ANNs may be adapted to control the radio nodes, the CNN/s may be used for training the ANNs. This approach allows distributed operation, but centralised control and/or learning, which is particularly suitable for a wireless communication system, with associated communication delays and/or limited visibility of a complete system status for individual nodes.

It should be noted that phase formats and/or phase ambiguity limitation of input and output may be different (considering, e.g. that input and output may pertain to different spaces). Phase ambiguity limitation for the input may be referred to as first or initial or input phase ambiguity limitation; phase ambiguity limitation for the output may be referred to as second or output or exit phase ambiguity limitation.

In general, the input may be based on different information provided by and/or pertaining to a plurality of sources, e.g. radio nodes or ANNs or control nodes. The information from one source may pertain to, and/or represent a part of the status of the system, e.g. the radio environment.

It may be considered that an available input space is limited based on a phase ambiguity limitation, e.g. by limiting information to be included for the input, or by providing a mapping to allowable input. Thus, ambiguity of ML initiation may be limited, allowing faster learning to be performed. An input space may generally represent the potential statuses of the system in suitable parametrisation; the parametrisation may be phase-invariant, e.g. such that phase ambiguity may be present without the suggested phase ambiguity limitation.

It may be considered that the input phase ambiguity limitation may be a phase ambiguity elimination. An elimination may lead to no phase ambiguity is left in the input, e.g. such that all inputs are mapped to a prescribed phase format.

It may be considered that the input or status may corresponds to, and/or comprise, a channel estimate (which may occur to controlling the system according to a previous action). The channel estimate may be used as phase-invariant representation for the system's behaviour or status.

In general, an optimisation may be performed based on the status; in particular, a capacity as optimisation parameter or parametrisation may be determined based on the status. A channel estimate may be a particular suitable input parametrisation for such optimisation.

The input may represent one status from a status space of available statuses (corresponding to an input space). The input space or status space may be limited to certain phase formats, e.g. one phase format, or a small number of such (e.g., 8 or fewer, or 4 or fewer).

A radio node for a wireless communication system is described. The radio node is adapted for providing (e.g., operation) information for an input to a machine learning system as described herein, and/or for being controlled based on an output and/or action provided by a machine learning system as described herein. The radio node may be directly or indirectly be connected or connectable to the MLS, and/or may be controlled or controllable by an agent or ANN associated to, and/or part of, the MLS. Suitable communication interfaces may be provided, e.g. radio interface or cable interface. The radio node may in particular be a network node or base station. The radio node may be adapted to perform phase ambiguity limitation or elimination regarding the information or input, and/or regarding information representing an action for the radio node (e.g., received from the MLS, and/or based on an output of the MLS), e.g. according to a predefined or configured phase format (and/or different formats associated to input and/or actions), and/or based on a PAE function or PAL function, e.g. regarding status and/or a channel estimation representation. Multiple radio nodes may utilise the same function and/or phase format for their respective inputs and/or actions. Information representing action for a radio node may represent and/or be based on a part of the output of a MLS pertaining to the radio node, e.g. indicating control information and/or a precoder and/or weights to be used by the radio node.

There is also considered a wireless communication system comprising a plurality of radio nodes as described herein, and/or adapted to be controlled based on an output and/or action provided by a machine learning system as described herein, and/or adapted for providing information for an input for a machine learning system as described herein.

A method of training a machine learning system as described herein may be considered. The method comprises performing machine learning for the system. For example, multiple cycles of providing input to the MLS, using the output to control a wireless communication system, using generated input based on such control for a further cycle, etc. may be considered.

There is also described a program product comprising instructions causing processing circuitry to control and/or perform and/or implement a machine learning system as described herein. Moreover, a carrier medium arrangement carrying and/or storing a program product as described herein is considered. An information system comprising, and/or connected or connectable, to a wireless communication system and/or radio node and/or machine learning system is also disclosed.

### BRIEF DESCRIPTION OF THE DRAWINGS

The drawings are provided to illustrate concepts and approaches described herein, and are not intended to limit their scope. The drawings comprise:

FIG. 1, showing an exemplary wireless communication scenario; and

FIGS. 2a and 2b, showing exemplary scenarios using phase ambiguity limitation.

### DETAILED DESCRIPTION

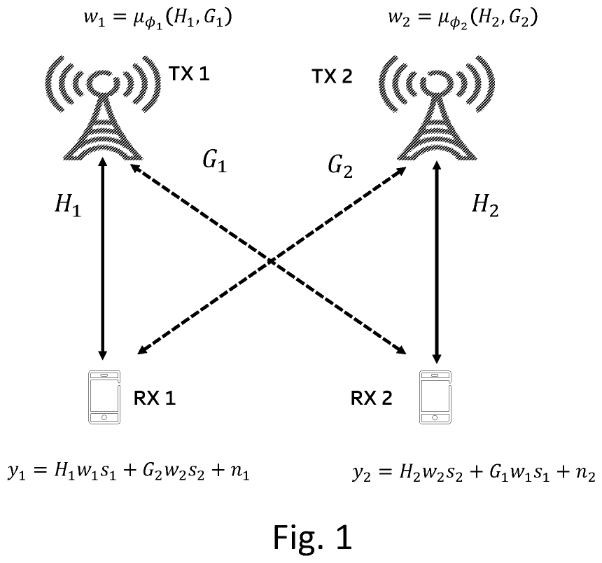

FIG. 1 schematically shows a wireless communication network with radio nodes TX1, TX2, which may represent base stations or network nodes; a MU-MIMO scenario is described. Wireless devices RX1, RX2 may be in communication with TX1, TX2, RX1 is connected to TX1 via radio link H1, and to TX2 via radio link G2, RX2 is connected to TX2 via radio link H2, and to TX1 via radio link G1, H1, H2, G1, G2 may represent channel matrices representing channel estimates or states. w1, w2 represent the precoders used by TX1, TX2 to communicate with both RX1 and RX2. y1, y2 represent received signals, with s1, s2 representing signals from TX1 and TX2. n1, n2 represent noise. The radio links use beamforming according to w1, w2.

A MLS may be used for controlling a network, e.g. a network shown in FIG. 1. Multiple channels between multiple radio nodes TX and wireless device RX may be considered. In general, for a baseband representation of channels,

$$c = [ {a}_{1} exp ( j {ϑ}_{1} ) , {a}_{2} exp ( j {ϑ}_{2} ) , … , {a}_{{n}_{t}} exp ( j {ϑ}_{{n}_{t}} ) ] \qquad ( 1 )$$

may hold. αᵢ and ϑᵢ may be the amplitude and phase of the i-th element of c.

An exemplary PAE function may be used:

$${f}_{PAE} ( c ) = [ {a}_{1} , {a}_{2} exp ( j ( {ϑ}_{2} - {ϑ}_{1} ) ) , … , {a}_{{n}_{t}} exp ( j ( {ϑ}_{{n}_{t}} - {ϑ}_{1} ) ) ] . \qquad ( 2 )$$

An accurate environmental state (channel estimate) may be obtained by applying the mapping function ƒ_{PAE} to hᵢ and gᵢ as

$${s}_{i}^{PAE} = [ {f}_{PAE} ( {h}_{i} ) , {f}_{PAE} ( {g}_{i} ) ] . \qquad ( 3 )$$

In general, for radio communication, a passband channel transmission may be represented by a complex-valued baseband equivalent, which may be denoted as

$$Y = Hws + N \qquad ( 4 )$$

wherein: s is a transmitted signal or vector, w is a precoding vector or matrix, H is a MIMO channel matrix, N is an AWGN vector (noise) and Y is a received signal or signal vector. H may be considered representative of a state of the system, and/or may represent and/or correspond to an input for a MLS. H and w may comprise multiple components or elements (e.g., H1, H2, G1, G2, . . . or w1, w2, . . . , respectively) associated to different channels and/or transmitters or radio nodes of the system. w may represent an action of the system, e.g. to be provided by the MLS. If w is provided as action to control the wireless communication system, a channel estimate or state H may result based on applying w. Based on an input state H, w may be determined as output by the MLS, and/or an output may correspond to w. Applying w may lead to beamforming being performed by the radio nodes or network nodes according to w.

The channel capacity may be determined as

$${log}_{2} det ( I + ρ ( Hw ) {( Hw )}^{h} ) \qquad ( 5 )$$

wherein ρ is a SNR parameter and ( . . . )^{h} denotes a Hermitian transpose. Each element of these vector/matrix representations is complex-valued in Cartesian or polar exponential form

$$e = a + jb = α exp ( j θ ) \qquad ( 6 )$$

In an exemplary case, a rank-1 precoding (e.g., using only one layer of transmission) over a 3-by-3 channel may be represented as:

$$Y = Hws + N = [ \begin{matrix}{a}_{11} exp ( j {θ}_{11} ) & {a}_{12} exp ( j {θ}_{12} ) & {a}_{13} exp ( j {θ}_{13} ) \\ {a}_{21} exp ( j {θ}_{21} ) & {a}_{22} exp ( j {θ}_{22} ) & {a}_{23} exp ( j {θ}_{23} ) \\ {a}_{31} exp ( j {θ}_{31} ) & {a}_{32} exp ( j {θ}_{32} ) & {a}_{33} exp ( j {θ}_{33} )\end{matrix} ] ws + N \qquad ( 7 )$$

In general, the capacity for matrices H and exp(jθ)H for any θ is the same for a given precoder, thus there is phase ambiguity for an input. The capacity may generally represent an optimisation parameter for the MLS.

For a given channel H, precoders w and exp(jθ)w for any θ provide the same performance, thus there is phase ambiguity for an output. From a perspective of operating the wireless communication system, this may not be considered a problematic issue, as the results of control with phase-ambiguous precoding are acceptable.

It has been recognised however, that for optimising using ML, it may be advantageous to limit input space and/or output space for the MLS; this may improve efficiency and provide better quality solutions. In particular, it has been noted that for the input, performance degradation for the MLS may occur due to a many-to-one mapping between a set of input phase-shifted channel states and the output target optimal action due to the phase ambiguity. An input phase ambiguity limitation or elimination may be utilised for the input, e.g. mapping H and exp(jθ)H to the same H̅. This may be considered to represent a limitation of phase format of the input. For the output, phase ambiguity may lead to a one-to-many mapping of actions/solutions, which may lead to performance degradation for the training of the MLS. An output phase ambiguity limitation (or PAE) may be utilised to limit outputs, e.g. to provide w̅. In general, H̅ may be considered an element of an input space (status space) that is limited relative to an input space comprising all possible statuses of the system; w̅ may be considered an element of an output space (action space) that is limited relative to all possible outputs that may applicable to the system.

On example of input PAE may fix a phase term exp(jθ) of one matrix element of a matrix H, e.g. such that exp(jθ)=1 for this element. This may be performed using a transforming of H, such that:

$$H = [ \begin{matrix}{a}_{11} exp ( j {θ}_{11} ) & {a}_{12} exp ( j {θ}_{12} ) & {a}_{13} exp ( j {θ}_{13} ) \\ {a}_{21} exp ( j {θ}_{21} ) & {a}_{22} exp ( j {θ}_{22} ) & {a}_{23} exp ( j {θ}_{23} ) \\ {a}_{31} exp ( j {θ}_{31} ) & {a}_{32} exp ( j {θ}_{32} ) & {a}_{33} exp ( j {θ}_{33} )\end{matrix} ] \to \overline{H} \qquad ( 8 )$$

$$with$$

$$\overline{H} = [ \begin{matrix}{a}_{11} & {a}_{12} exp ( j ( {θ}_{12} - {θ}_{11} ) ) & {a}_{13} exp ( j {θ}_{13} - {θ}_{11} ) ) \\ {a}_{21} exp ( j {θ}_{21} - {θ}_{11} ) ) & {a}_{22} exp ( j {θ}_{22} - {θ}_{11} ) ) & {a}_{23} exp ( j {θ}_{23} - {θ}_{11} ) ) \\ {a}_{31} exp ( j {θ}_{31} - {θ}_{11} ) ) & {a}_{32} exp ( j {θ}_{32} - {θ}_{11} ) ) & {a}_{33} exp ( j {θ}_{33} - {θ}_{11} ) )\end{matrix} ] \qquad ( 9 )$$

The transformation may be to achieve a prescribed phase format, e.g. setting one matrix element (in the example exp(jθ₁₁), but a different element may be used) to a fixed phase term (in the example, θ₁₁=0, exp(jθ₁₁)=1). The transformation or function may correspond to a phase rotation or phase shift of the matrix. Fixing a phase term of one element may be considered defining the phase format (all potential inputs may be transformed accordingly).

An exemplary approach of output phase ambiguity limitation or elimination may comprise co-phasing of one of the elements of a precoding vector or weight vector. In particular, solution for the MLS may be limited to elements of an output space that only comprises limited (co-phased) vectors; alternatively, solutions may be subject to a co-phasing mapping before provided as output.

For example,

$$H \to \overline{w} = [ p 1 , p 2 , p 3 , q 2 , q 3 ] = [ \begin{matrix}p 1 + j 0 \\ p 2 + jq 2 \\ p 3 + jq 3\end{matrix} ] \qquad ( 10 )$$

may be used for co-phasing the first element of the vector. For larger systems, larger matrices may be used analogously. In general, any element of the precoder or weight vector (or other matrix or vector representing an action) may be co-phased. Co-phasing may be considered a PAE or PAL function, e.g. similar to a phase rotation or shift.

Equivalent or isomorphical transformations may be considered, e.g. for other parametrisations than polar representation.

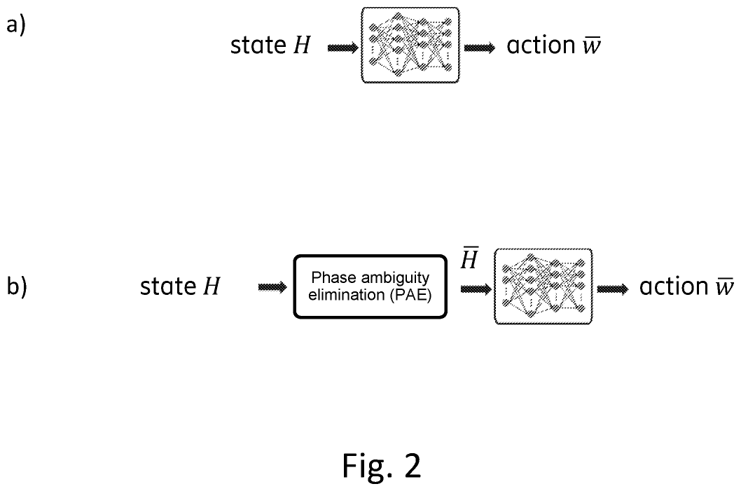

FIG. 2a, 2b show examplary scenarios for phase ambiguity limitation. FIG. 2a shows an example in which based on an input H, a MLS provides an action w̅ as output, based on output phase ambiguity elimination or limitation. FIG. 2b shows an example in which a state H is subject to a PAE before being provided as input H̅ to a MLS, which then provides an action w̅ as output, based on output phase ambiguity elimination or limitation. FIG. 2a) faciliates efficient and quick learning, as possible output parametrisations may be limited; according to FIG. 2b), both potential input and output are limited, providing even more efficient ML. The MLS in FIGS. 2a, 2b is represented by a schematically drawn neural network.

Moreover, there may be generally considered a method of operating an information system, the method comprising providing information. Alternatively, or additionally, an information system adapted for providing information may be considered. Providing information may comprise providing information for, and/or to, a target system, which may comprise and/or be implemented as wireless communication network or radio access network and/or a radio node, in particular a network node or user equipment or terminal. Providing information may comprise transferring and/or streaming and/or sending and/or passing on the information, and/or offering the information for such and/or for download, and/or triggering such providing, e.g. by triggering a different system or node to stream and/or transfer and/or send and/or pass on the information. The target system may be controlled or controllable by a MLS described herein. The information system may comprise, and/or be connected or connectable to, a target, for example via one or more intermediate systems, e.g. a core network and/or internet and/or private or local network. Information may be provided utilising and/or via such intermediate system/s. Providing information may be for radio transmission and/or for transmission via an air interface and/or utilising a RAN or radio node as described herein. Connecting the information system to a target, and/or providing information, may be based on a target indication, and/or adaptive to a target indication. A target indication may indicate the target, and/or one or more parameters of transmission pertaining to the target and/or the paths or connections over which the information is provided to the target. Such parameter/s may in particular pertain to the air interface and/or radio access network and/or radio node and/or network node. Example parameters may indicate for example type and/or nature of the target, and/or transmission capacity (e.g., data rate) and/or latency and/or reliability and/or cost, respectively one or more estimates thereof. The target indication may be provided by the target, or determined by the information system, e.g. based on information received from the target and/or historical information, and/or be provided by a user, for example a user operating the target or a device in communication with the target, e.g. via the RAN and/or air interface. For example, a user may indicate on a user equipment communicating with the information system that information is to be provided via a RAN, e.g. by selecting from a selection provided by the information system, for example on a user application or user interface, which may be a web interface. An information system may comprise one or more information nodes. An information node may generally comprise processing circuitry and/or communication circuitry. In particular, an information system and/or an information node may be implemented as a computer and/or a computer arrangement, e.g. a host computer or host computer arrangement and/or server or server arrangement. In some variants, an interaction server (e.g., web server) of the information system may provide a user interface, and based on user input may trigger transmitting and/or streaming information provision to the user (and/or the target) from another server, which may be connected or connectable to the interaction server and/or be part of the information system or be connected or connectable thereto. The information may be any kind of data, in particular data intended for a user of for use at a terminal, e.g. video data and/or audio data and/or location data and/or interactive data and/or game-related data and/or environmental data and/or technical data and/or traffic data and/or vehicular data and/or circumstantial data and/or operational data. The information provided by the information system may be mapped to, and/or mappable to, and/or be intended for mapping to, communication or data signaling and/or one or more data channels as described herein (which may be signaling or channel/s of an air interface and/or used within a RAN and/or for radio transmission). It may be considered that the information is formatted based on the target indication and/or target, e.g. regarding data amount and/or data rate and/or data structure and/or timing, which in particular may be pertaining to a mapping to communication or data signaling and/or a data channel. Mapping information to data signaling and/or data channel/s may be considered to refer to using the signaling/channel/s to carry the data, e.g. on higher layers of communication, with the signaling/channel/s underlying the transmission. A target indication generally may comprise different components, which may have different sources, and/or which may indicate different characteristics of the target and/or communication path/s thereto. A format of information may be specifically selected, e.g. from a set of different formats, for information to be transmitted on an air interface and/or by a RAN as described herein. This may be particularly pertinent since an air interface may be limited in terms of capacity and/or of predictability, and/or potentially be cost sensitive. The format may be selected to be adapted to the transmission indication, which may in particular indicate that a RAN or radio node as described herein is in the path (which may be the indicated and/or planned and/or expected path) of information between the target and the information system. A (communication) path of information may represent the interface/s (e.g., air and/or cable interfaces) and/or the intermediate system/s (if any), between the information system and/or the node providing or transferring the information, and the target, over which the information is, or is to be, passed on. A path may be (at least partly) undetermined when a target indication is provided, and/or the information is provided/transferred by the information system, e.g. if an internet is involved, which may comprise multiple, dynamically chosen paths. Information and/or a format used for information may be packet-based, and/or be mapped, and/or be mappable and/or be intended for mapping, to packets. Alternatively, or additionally, there may be considered a method for operating a target device comprising providing a target indicating to an information system. More alternatively, or additionally, a target device may be considered, the target device being adapted for providing a target indication to an information system. In another approach, there may be considered a target indication tool adapted for, and/or comprising an indication module for, providing a target indication to an information system. The target device may generally be a target as described above. A target indication tool may comprise, and/or be implemented as, software and/or application or app, and/or web interface or user interface, and/or may comprise one or more modules for implementing actions performed and/or controlled by the tool. The tool and/or target device may be adapted for, and/or the method may comprise, receiving a user input, based on which a target indicating may be determined and/or provided. Alternatively, or additionally, the tool and/or target device may be adapted for, and/or the method may comprise, receiving information and/or communication signaling carrying information, and/or operating on, and/or presenting (e.g., on a screen and/or as audio or as other form of indication), information.

The information may be based on received information and/or communication signaling carrying information. Presenting information may comprise processing received information, e.g. decoding and/or transforming, in particular between different formats, and/or for hardware used for presenting. Operating on information may be independent of or without presenting, and/or proceed or succeed presenting, and/or may be without user interaction or even user reception, for example for automatic processes, or target devices without (e.g., regular) user interaction like MTC devices, of for automotive or transport or industrial use. The information or communication signaling may be expected and/or received based on the target indication. Presenting and/or operating on information may generally comprise one or more processing steps, in particular decoding and/or executing and/or interpreting and/or transforming information. Operating on information may generally comprise relaying and/or transmitting the information, e.g. on an air interface, which may include mapping the information onto signaling (such mapping may generally pertain to one or more layers, e.g. one or more layers of an air interface, e.g. RLC (Radio Link Control) layer and/or MAC layer and/or physical layer/s). The information may be imprinted (or mapped) on communication signaling based on the target indication, which may make it particularly suitable for use in a RAN (e.g., for a target device like a network node or in particular a UE or terminal). The tool may generally be adapted for use on a target device, like a UE or terminal. Generally, the tool may provide multiple functionalities, e.g. for providing and/or selecting the target indication, and/or presenting, e.g. video and/or audio, and/or operating on and/or storing received information. Providing a target indication may comprise transmitting or transferring the indication as signaling, and/or carried on signaling, in a RAN, for example if the target device is a UE, or the tool for a UE. It should be noted that such provided information may be transferred to the information system via one or more additionally communication interfaces and/or paths and/or connections. The target indication may be a higher-layer indication and/or the information provided by the information system may be higher-layer information, e.g. application layer or user-layer, in particular above radio layers like transport layer and physical layer. The target indication may be mapped on physical layer radio signaling, e.g. related to or on the user-plane, and/or the information may be mapped on physical layer radio communication signaling, e.g. related to or on the user-plane (in particular, in reverse communication directions). The described approaches allow a target indication to be provided, facilitating information to be provided in a specific format particularly suitable and/or adapted to efficiently use an air interface. A user input may for example represent a selection from a plurality of possible transmission modes or formats, and/or paths, e.g. in terms of data rate and/or packaging and/or size of information to be provided by the information system.

An antenna arrangement may comprise one or more antenna elements (radiating elements), which may be combined in antenna arrays. An antenna array or subarray may comprise one antenna element, or a plurality of antenna elements, which may be arranged e.g. two dimensionally (for example, a panel) or three dimensionally. It may be considered that each antenna array or subarray or element is separately controllable, respectively that different antenna arrays are controllable separately from each other. A single antenna element/radiator may be considered the smallest example of a subarray. Examples of antenna arrays comprise one or more multi-antenna panels or one or more individually controllable antenna elements. An antenna arrangement may comprise a plurality of antenna arrays. It may be considered that an antenna arrangement is associated to a (specific and/or single) radio node, e.g. a configuring or informing or scheduling radio node, e.g. to be controlled or controllable by the radio node. An antenna arrangement associated to a UE or terminal may be smaller (e.g., in size and/or number of antenna elements or arrays) than the antenna arrangement associated to a network node. Antenna elements of an antenna arrangement may be configurable for different arrays, e.g. to change the beamforming characteristics. In particular, antenna arrays may be formed by combining one or more independently or separately controllable antenna elements or subarrays. The beams may be provided by analog beamforming, or in some variants by digital beamforming, or by hybrid beamforming combing analog and digital beamforming. The informing radio nodes may be configured with the manner of beam transmission, e.g. by transmitting a corresponding indicator or indication, for example as beam identify indication. However, there may be considered cases in which the informing radio node/s are not configured with such information, and/or operate transparently, not knowing the way of beamforming used. An antenna arrangement may be considered separately controllable in regard to the phase and/or amplitude/power and/or gain of a signal feed to it for transmission, and/or separately controllable antenna arrangements may comprise an independent or separate transmit and/or receive unit and/or ADC (Analog-Digital-Converter, alternatively an ADC chain) or DCA (Digital-to-Analog Converter, alternatively a DCA chain) to convert digital control information into an analog antenna feed for the whole antenna arrangement (the ADC/DCA may be considered part of, and/or connected or connectable to, antenna circuitry) or vice versa. A scenario in which an ADC or DCA is controlled directly for beamforming may be considered an analog beamforming scenario; such controlling may be performed after encoding/decoding and/or after modulation symbols have been mapped to resource elements. This may be on the level of antenna arrangements using the same ADC/DCA, e.g. one antenna element or a group of antenna elements associated to the same ADC/DCA. Digital beamforming may correspond to a scenario in which processing for beamforming is provided before feeding signaling to the ADC/DCA, e.g. by using one or more precoder/s and/or by precoding information, for example before and/or when mapping modulation symbols to resource elements. Such a precoder for beamforming may provide weights, e.g. for amplitude and/or phase, and/or may be based on a (precoder) codebook, e.g. selected from a codebook. A precoder may pertain to one beam or more beams, e.g. defining the beam or beams. The codebook may be configured or configurable, and/or be predefined. DFT beamforming may be considered a form of digital beamforming, wherein a DFT procedure is used to form one or more beams. Hybrid forms of beamforming may be considered.

In general, a critic network (or each of the critic networks) may receive operation information from a plurality of the actor neural networks. The plurality may comprise actor neural networks (ANN) not receiving learning feedback from the critic network and/or not trained by the critic network and/or not associated to the critic network and/or associated to another critic network. In some cases, the plurality of ANNs may represent the ANNs associated to the plurality of radio nodes, or to a subset thereof. The learning feedback for one ANN may be based on, and/or be determined based on, operation information from the plurality of ANNs. It may be considered that the learning feedback is representative of, and/or based on, machine learning performed by the critic network and/or provided by the critic network to the ANN. A critic network may be a critic neural network, e.g. for machine learning and/or artificial intelligence. The critic network may determine the learning feedback for an ANN and/or radio node and/or agent based on operating the ANN, e.g. a copy thereof. The copy may correspond to the state of the ANN used for operating the radio node as represented by the operation information, in particular activity information. The critic network may be a neural network adapted for monitoring and/or evaluating and/or performing reinforcement learning on one or more ANNs.

Operation information, e.g. provided from one or more ANNs or radio nodes or pertaining to one or more radio nodes and/or associated states, may represent training data for a machine learning system, e.g. for one or more components or neural networks of the system, e.g. for a critic network. For an machine learning system, the learning feedback and/or operation information, and/or local (e.g., performed by the associated radio node/s) measurements, and/or activity information, and/or radio environment information may be considered training data. The learning feedback may represent reward information, e.g. for and/or from reward-based learning, and/or control information and/or parameters for operating the ANN and/or associated radio node. In some cases, the learning feedback may represent and/or determine a new learning or operating state of the ANN and/or a trained and/or updated ANN. It should be noted that the training may be before actual operation of the network/s, and/or be performed while operating the network, e.g. to provide radio access for users. The terms training and learning may be considered to be essentially exchangeable, at least from the point of view of a network being trained. In general, reward-based learning may also be referred to a reinforcement learning. The approaches described herein may comprise multiple loops of controlling radio nodes and/or providing operation information and/or receiving learning feedback.

A neural network associated to another neural network may be connected or connectable to the other network for communicating and/or exchanging information and/or feedback, e.g. operation information and/or learning feedback. The connection may be cable-bound, and/or wirelessly, e.g. via a radio access network or a backhaul network, in particular an IAB network. A network associated to a radio node may be a network connected or connectable to, and/or implemented as part of, the radio node, e.g. to control the radio node and/or to receive information from it, in particular operation information. It may be considered that a neural network like a ANN or critic network is implemented as and/or comprises firmware and/or software and/or hardware and/or data, e.g. training data and/or operation data. Hardware may in particular comprise processing circuitry and/or communication circuitry; the neural network, and/or software or firmware components thereof, may adapted to be operating or operable running on the processing circuitry, and/or to use the communication circuitry for communicating with connected or connectable network/s and/or device/s. An actor neural network may in general be a neural network adapted for controlling the associated radio node/s, e.g. in terms of beamforming to be used for communicating (e.g., receiving and/or transmission), and/or for scheduling and/or other operation. The actor neural network may in particular be adapted for determining precoders and/or precoding and/or for link adaption (e.g., determining MCS) for transmission of signaling and/or reception of signaling. An ANN implemented and/or connected or connectable to be operational to control a radio node may be considered an agent. The machine learning system may be considered a precoding policy network, e.g. providing precoders for the wireless communication network.

It maybe considered that the operation information may comprise radio environment information and/or experiences. The radio environment information and/or experience may represent channel estimates and/or measurements and/or signal quality and/or signal strength and/or data throughput and/or interference and/or signaling characteristics, in particular beam signaling characteristics, e.g. pertaining to one or more beams (in particular, reception beams and/or transmission beams for a radio node). Information pertaining to transmission beams may be provided to a radio node based on feedback received from other radio nodes or devices, e.g. wireless devices connected to a radio node. Radio environment information may be provided to the ANN, e.g. based on measurements performed by, and/or information determined or obtained by, the associated radio node/s. Radio environment information may pertain to one or more carriers, and/or parts thereof, e.g. bandwidth parts. It may be considered that the radio environment information and/or experiences are determined after and/or during a radio node is or has been controlled for operation by an agent or ANN, e.g. corresponding to some activity information. Thus, radio environment information may be in reaction to activity represented or representable by activity information.

A wireless communication system may be beamforming system and/or a MIMO system, e.g. allowing multiple users to be connected, and/or multiple beams to be transmitted and/or received simultaneously. Beamforming may be performed based on one or more precoder/s. In particular, beamforming may be non-codebook based (without fixed and/or predefined and/or configured precoder/s); however, codebook based beamforming may be considered, in which configured and/or configurable beams from a set of beams may be used, and/or communication partners may agree on a set of precoders and/or beams, e.g. transmission beams.

The radio nodes may in particular be and/or comprise network radio nodes, e.g. base stations and/or IAB nodes and/or relay nodes. However, in some cases, the radio nodes may comprise one or more wireless devices like terminals and/or UEs. Information provided by a radio node for a critic network may be provided via one or more layers of communication and/or protocols and/or processing steps; these may include an agent or ANN, but in some cases may circumvent the agent or ANN. For example, radio environment information may be provided directly to a critic network. A network node of the radio nodes may control operation of associated wireless device or UEs based on the action and/or learning feedback and/or beamforming parameter/s, e.g. with control signaling transmitted to the device/s.

It may be considered that the operation information may comprises activity information. Activity information may comprise information representing activity performed by an agent and/or ANN, in particular controlling one or more radio nodes associated thereto. Activity information may for example represent and/or indicate one or more precoders, and/or beamforming parameters used for beamforming, e.g. representing beamforming weights and/or phase shifts and/or antenna port/s and/or transmission power (note that transmission power for a received beam may be represented by, and/or determined based on a path loss), and/or duration and/or beam sweeping characteristics and/or beam angular extension and/or lobes and/or polarisation and/or which antenna/s or antenna arrays have been or are used. Alternatively, or additionally, the activity information may comprise information regarding scheduled and/or actually transmitted and/or received signaling, in particular signaling carried on the beam/s, e.g. signaling characteristics and/or channel information (e.g., whether and/or which data channel and/or control channel is used) and/or the modulation and/or coding scheme, and/or code rate, and/or transmission format. The activity information may be associated to radio environment information, which may also be included in the operation information: The radio environment information may represent a time after and/or during the activity (e.g., one or more points in time). In some cases, a time before the activity may be included, e.g. as a reference.

Operation information provided by different actor neural networks may comprise radio environment information pertaining to different parts of the radio environment, e.g. geographically different (e.g., due to different locations) and/or different section or cells. Thus, the learning and/or training may consider larger scales or areas than observable by one radio node or ANN.

It may be considered that operation information may comprise radio environment information. Radio environment information may be represented and/or representable by channel matrix information, e.g. indicating channel conditions and/or channel estimations, pertaining to one or more radio channels and/or beams and/or types of signaling as seen and/or determined and/or obtained by a radio node and/or its associated ANN.

In some variants, learning feedback may be based on, and/or represent, reward learning. The critic network may learn based on reward learning, and/or may provide the learning feedback based on such learning. Reward learning may reward desired or more desirable solutions with a reward signal (or deny such for undesirable solutions). The reward signal may be based on achieving a target set of conditions, e.g. pertaining to a plurality of radio nodes and/or ANNs, with activity information and/or associated radio environment information. Providing a reward signal to an ANN as training data or learning feedback may allow low signaling overhead.

It may be considered that a critic network is associated to a plurality of actor neural networks, e.g., to all of the ANNs, or to a subset. There may be one critic network, allowing centralised learning for all ANNs. In some cases, there may be more than one critic network, which may be adapted to communicate with each other or not; in this case, learning for multiple ANNs may be combined (in particular, the operation information may be combined for learning). There may be one critic network for each ANN, or one critic network for a plurality of ANNs.

Approaches are particularly suitable for millimeter wave communication, in particular for radio carrier frequencies around and/or above 52.6 GHz, which may be considered high radio frequencies (high frequency) and/or millimeter waves. The carrier frequency/ies may be between 52.6 and 140 GHz, e.g. with a lower border between 52.6, 55, 60, 71 GHz and/or a higher border between 71, 72, 90, 114, 140 GHz or higher, in particular between 55 and 90 GHz, or between 60 and 72 GHz; however, higher or lower frequencies may be considered. The carrier frequency may in particular refer to a center frequency or maximum frequency of the carrier. The radio nodes and/or network described herein may operate in wideband, e.g. with a carrier bandwidth of 1 GHz or more, or 2 GHz or more, or even larger, e.g. up to 8 GHz; the scheduled or allocated bandwidth may be the carrier bandwidth, or be smaller, e.g. depending on channel and/or procedure. In some cases, operation may be based on an OFDM waveform or a SC-FDM waveform (e.g., downlink and/or uplink), in particular a FDF-SC-FDM-based waveform. However, operation based on a single carrier waveform, e.g. SC-FDE (which may be pulse-shaped or Frequency Domain Filtered, e.g. based on modulation scheme and/or MCS), may be considered for downlink and/or uplink. In general, different waveforms may be used for different communication directions. Communicating using or utilising a carrier and/or beam may correspond to operating using or utilising the carrier and/or beam, and/or may comprise transmitting on the carrier and/or beam and/or receiving on the carrier and/or beam. The approaches are particularly advantageously implemented in a 5th Generation (5G) telecommunication network or 5G radio access technology or network (RAT/RAN), in particular according to 3GPP (3rd Generation Partnership Project, a standardisation organization). A suitable RAN may in particular be a RAN according to NR, for example release 15 or later, or LTE Evolution. However, the approaches may also be used with other RAT, for example future 5.5G or 6G systems or IEEE based systems. For such systems, beamforming and/or MIMO used may be of particular importance; in particular, for high frequencies, strong beamforming may be used to overcome strong signal absorption.

In this disclosure, for purposes of explanation and not limitation, specific details are set forth (such as particular network functions, processes and signaling steps) in order to provide a thorough understanding of the technique presented herein. It will be apparent to one skilled in the art that the present concepts and aspects may be practiced in other variants and variants that depart from these specific details.

For example, the concepts and variants are partially described in the context of Long Term Evolution (LTE) or LTE-Advanced (LTE-A) or New Radio mobile or wireless communications technologies, or in the context of 6G technology; however, this does not rule out the use of the present concepts and aspects in connection with additional or alternative mobile communication technologies such as the Global System for Mobile Communications (GSM) or IEEE standards as IEEE 802.11ad or IEEE 802.11 ay. While described variants may pertain to certain Technical Specifications (TSs) of the Third Generation Partnership Project (3GPP), it will be appreciated that the present approaches, concepts and aspects could also be realized in connection with different Performance Management (PM) specifications.

Moreover, those skilled in the art will appreciate that the services, functions and steps explained herein may be implemented using software functioning in conjunction with a programmed microprocessor, or using an Application Specific Integrated Circuit (ASIC), a Digital Signal Processor (DSP), a Field Programmable Gate Array (FPGA) or general purpose computer. It will also be appreciated that while the variants described herein are elucidated in the context of methods and devices, the concepts and aspects presented herein may also be embodied in a program product as well as in a system comprising control circuitry, e.g. a computer processor and a memory coupled to the processor, wherein the memory is encoded with one or more programs or program products that execute the services, functions and steps disclosed herein.

It is believed that the advantages of the aspects and variants presented herein will be fully understood from the foregoing description, and it will be apparent that various changes may be made in the form, constructions and arrangement of the exemplary aspects thereof without departing from the scope of the concepts and aspects described herein or without sacrificing all of its advantageous effects. The aspects presented herein can be varied in many ways.

### Some Useful Abbreviations Comprise

Abbreviation Explanation
ACK/NACK Acknowledgment/Negative Acknowledgement
ANN Actor neural network
ARQ Automatic Repeat reQuest
BER Bit Error Rate
BLER Block Error Rate
BPSK Binary Phase Shift Keying
BWP Band Width Part
CAZAC Constant Amplitude Zero Cross Correlation
CB Code Block
CBB Code Block Bundle
CBG Code Block Group
CDM Code Division Multiplex
CM Cubic Metric
CNN Critic Neural Network
CORESET Control Resource Set
CQI Channel Quality Information
CRC Cyclic Redundancy Check
CRS Common reference signal
CSI Channel State Information
CSI-RS Channel state information reference signal
DAI Downlink Assignment Indicator
DCI Downlink Control Information
DFT Discrete Fourier Transform
DFTS-FDM DFT-spread-FDM
DM(-)RS Demodulation reference signal(ing)
eMBB enhanced Mobile BroadBand
FDD Frequency Division Duplex
FDE Frequency Domain Equalisation
FDF Frequency Domain Filtering
FDM Frequency Division Multiplex
HARQ Hybrid Automatic Repeat Request
IAB Integrated Access and Backhaul
ICI Inter Carrier Interference
IFFT Inverse Fast Fourier Transform
Im Imaginary part, e.g. for pi/2*BPSK modulation
IR Impulse Response
ISI Inter Symbol Interference
MBB Mobile Broadband
MCS Modulation and Coding Scheme
MIMO Multiple-input-multiple-output
ML Machine Learning
MLS Machine Learning System
MRC Maximum-ratio combining
MRT Maximum-ratio transmission
MU-MIMO Multiuser multiple-input-multiple-output
OFDM/A Orthogonal Frequency Division Multiplex/Multiple Access
PAPR Peak to Average Power Ratio
PAE Phase Ambiguity Elimination
PAL Phase Ambiguity Limitation
PDCCH Physical Downlink Control Channel
PDSCH Physical Downlink Shared Channel
PRACH Physical Random Access CHannel
PRB Physical Resource Block
PUCCH Physical Uplink Control Channel
PUSCH Physical Uplink Shared Channel
(P)SCCH (Physical) Sidelink Control Channel
PSS Primary Synchronisation Signal(ing)
PT-RS Phase Tracking Reference Signaling
(P)SSCH (Physical) Sidelink Shared Channel
QAM Quadrature Amplitude Modulation
OCC Orthogonal Cover Code
QPSK Quadrature Phase Shift Keying
PSD Power Spectral Density
RAN Radio Access Network
RAT Radio Access Technology
RB Resource Block
RE Resource Element
Re Real part (e.g., for pi/2*BPSK) modulation
RNTI Radio Network Temporary Identifier
RRC Radio Resource Control
RX Receiver, Reception, Reception-related/side
SA Scheduling Assignment
SC-FDE Single Carrier Frequency Domain Equalisation
SC-FDM/A Single Carrier Frequency Division Multiplex/Multiple Access
SCI Sidelink Control Information
SINR Signal-to-interference-plus-noise ratio
SIR Signal-to-interference ratio
SNR Signal-to-noise-ratio
SR Scheduling Request
SRS Sounding Reference Signal(ing)
SSS Secondary Synchronisation Signal(ing)
SVD Singular-value decomposition
TB Transport Block
TDD Time Division Duplex
TDM Time Division Multiplex
T-RS Tracking Reference Signaling or Timing Reference Signaling
TX Transmitter, Transmission, Transmission-related/side
UCI Uplink Control Information
UE User Equipment
URLLC Ultra Low Latency High Reliability Communication
VL-MIMO Very-large multiple-input-multiple-output
WD Wireless Device
ZF Zero Forcing
ZP Zero-Power, e.g. muted CSI-RS symbol

Abbreviations may be considered to follow 3GPP usage if applicable.

1. A machine learning system, the machine learning system configured to;
provide an output based on an input, the input representing a status of a wireless communication system comprising a plurality of radio nodes, the output representing an action for the wireless communication system, the machine learning system being configured for a phase ambiguity limitation regarding the output.

2. A machine learning system, the machine learning system configured to:
provide an output based on an input, the input representing a status of a wireless communication system comprising a plurality of radio nodes, the output representing an action for the wireless communication system, the machine learning system being trained based on a phase ambiguity limitation regarding the output.

3. The machine learning system according to claim 1, wherein the action corresponds to control information for the wireless communication system.

4. The machine learning system according to claim 1, wherein the output corresponds to a set of beamforming parameters.

5. The machine learning system according to claim 1, wherein the status represents a channel estimate of the wireless communication system.

6. The machine learning system according to claim 1, wherein the phase ambiguity limitation is a phase ambiguity elimination.

7. The machine learning system according to claim 1, wherein the output corresponds to a set of beamforming weights.

8. The machine learning system according to claim 1, wherein the output represents one action from an action space of available actions.

9. The machine learning system according to claim 1, wherein the phase ambiguity limitation limits an action space of available action by fixing at least one element or parameter of a beamforming weight representation.

10. The machine learning system according to claim 1, wherein the action is determined based on a capacity of the wireless communication system.

11. The machine learning system according to claim 1, wherein the action is determined based on an optimisation of the wireless communication system.

12. The machine learning system according to claim 1, wherein the machine learning system is comprised on one or both of:
one or more critic neural networks; and
one or more agent neural networks.

13. A radio node for a wireless communication system, the radio node configured to one or both:
provide information for an input to a machine learning system; and
be controlled based on an action provided by a machine learning system; and
the machine learning system being configured to provide an output based on the input, the input representing a status of a wireless communication system comprising a plurality of radio nodes, the output representing an action for the wireless communication system, the machine learning system being configured for a phase ambiguity limitation regarding the output.

14. A communication system, the wireless communication system one or more of:
comprising a plurality of radio nodes the radio node being configured to one or both:
provide information for an input to a machine learning system; and
be controlled based on an action provided by the machine learning system; and
the machine learning system being configured to provide an output based on the input, the input representing a status of a wireless communication system comprising a plurality of radio nodes, the output representing an action for the wireless communication system, the machine learning system being configured for a phase ambiguity limitation regarding the output;
configured to be controlled based on the output provided by the machine learning system; and
configured to provide information for the input for the machine learning system.

15. A method of training a machine learning system, the machine learning system being configured to provide an output based on the input, the input representing a status of a wireless communication system comprising a plurality of radio nodes, the output representing an action for the wireless communication system, the machine learning system being configured for a phase ambiguity limitation regarding the output, the method comprising:
performing machine learning for the system.

16. The machine learning system according to claim 2, wherein the action corresponds to control information for the wireless communication system.

17. The machine learning system according to claim 2, wherein the output corresponds to a set of beamforming parameters.

18. The machine learning system according to claim 2, wherein the status represents a channel estimate of the wireless communication system.

19. The machine learning system according to claim 2, wherein the phase ambiguity limitation is a phase ambiguity elimination.

20. The machine learning system according to claim 2, wherein the output corresponds to a set of beamforming weights.
